(19) United States
(12) Patent Application Publication
(10) Pub. No.: US 2009/0122565 A1
(43) Pub. Date: May 14, 2009

(54) Vehicle exterior lighting system

(75) Inventor: Michael Gibbons, Garden City, MI (US)

Correspondence Address: MACMILLAN, SOBANSKI & TODD, LLC, ONE MARITIME PLAZA-FIFTH FLOOR, 720 WATER STREET, TOLEDO, OH, 43604, US

(73) Assignee: Lear Corporation

(21) Appl. No.: 11/983,974

(22) Filed: Nov. 13, 2007

(51) Int. Cl. F21V 1/00

(52) U.S. Cl. 362/466

(57) ABSTRACT

A system for varying the output of an exterior light of a vehicle having a source of power further includes an exterior vehicle light operatively connected to the source power and a controller for controlling the exterior vehicle light. The controller is coupled between the exterior vehicle light and the source of power and generates a plurality of power output signals to the exterior vehicle light, wherein each of the plurality of power output signals defines a light effect.

### BACKGROUND

Various embodiments of an exterior lighting system are described herein. In particular, the embodiments described herein relate to an improved—exterior lighting system for a vehicle.

Known vehicle lighting systems are constructed to enable selective switching between the headlights, park lights (running lights), and turn signal lights. These lights maybe lamps, LEDs (light emitting diodes), or some other light source. The exterior lights maybe used in an Remote Keyless Entry (RKE) system. The user may press a lock or unlock button and the vehicle may give feedback in the form of blinking headlights, park lights, or turn signal lights. Some such RKE fobs may include a panic feature that might blink the exterior lights in some pattern. The exterior lights might also be used to indicate automatic opening and closing of doors. For example the driver of a van might press a button to open the left rear sliding door and the exterior lights on the left side of the vehicle might blink to indicate to others that the door is opening. Additionally, some lights, such as lights at the rear of the vehicle, may blink to indicate to others that the tailgate is opening or closing.

In other systems the “entry/exit delay” may be actuated by a remote keyless entry device. In such headlight systems, the headlights are moved between one of either an on position or an off position.

### SUMMARY

The present application describes various embodiments of an exterior light system for varying the output of an exterior light of a vehicle having a source of power. One embodiment of the exterior light system includes an exterior vehicle light operatively connected to the source power and a controller for controlling the exterior vehicle light. The controller is coupled between the exterior vehicle light and the source of power and generates a plurality of power output signals to the exterior vehicle light, wherein each of the plurality of power output signals defines a light effect.

Other advantages of the vehicle exterior light system will become apparent to those skilled in the art from the following detailed description, when read in light of the accompanying drawings.

### BRIEF DESCRIPTION OF THE DRAWINGS

FIG. 1 is a block diagram of a system of a first embodiment of a vehicle exterior light system.

FIG. 2 is a schematic diagram illustrating a control signal (Pulse Width Modulation (PWM) signal) from the transistor and illustrating the exterior lights fading from an off position to an on position.

FIG. 3 is a schematic diagram illustrating a control signal (PWM signal) from the transistor and illustrating the exterior lights fading from an on position to an off position.

FIG. 4 is a schematic diagram illustrating a control signal (PWM signal) from the transistor and illustrating the exterior lights being illuminated intermittently.

FIG. 5 is a block diagram of a system of a second embodiment of a vehicle exterior light system.

FIG. 6 is a block diagram of a system of a third embodiment of a vehicle exterior light system.

### DETAILED DESCRIPTION

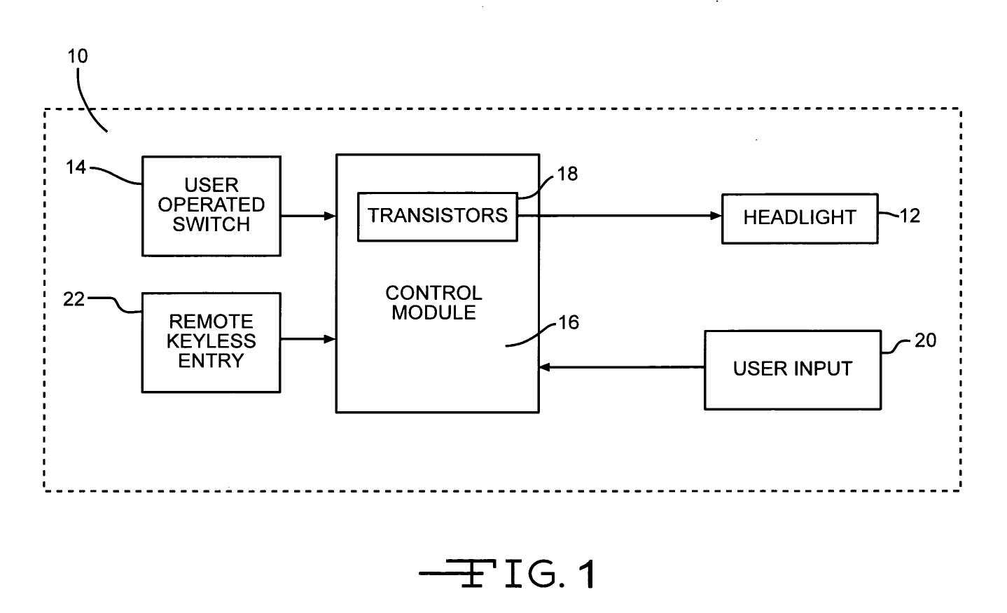

Referring now to FIG. 1, there is shown generally at 10 a first embodiment of a vehicle exterior lighting system for controlling one or more exterior lights 12 of a vehicle (not shown). In the embodiment illustrated in FIG. 1, the exterior vehicle light 12 is a headlight. It will be understood however, that the exterior vehicle lights 12 may be any desired light, such as for example, a low-beam headlight, a high-beam headlight, a turn signal, a park light, and any other exterior vehicle light.

The illustrated system 10 includes headlights 12, only one of which is shown, a user operated switch 14, such as a headlight switch or a turn signal switch, a control module 16, and one or more transistors 18. The transistors 18 are used to deliver electric current from a power source (not shown) to the exterior vehicle lights, such as the headlight 12. The exterior light 12 and user operated switch 14 are communicatively coupled to the control module 16. Each transistor 18 generates at least one Pulse Width Modulation (PWM) signal for varying the duty cycle of the exterior light, for example the headlight 12, such as to cause the headlight 12 to fade-on, fade-off, and/or flicker, as described in detail herein below.

The control module 16 may be any type of control module, such as a body control module for controlling electronic devices such as door locks, interior and exterior lights, and other, non-engine electronic devices. Alternatively, the control module may be a controller for controlling only one or more vehicle lights.

The transistor 18 may be any desired transistor in which the output current is controlled by a variable electric field. One example of a transistor that may be used in the illustrated embodiment is a Metal Oxide Semi-conductor Field Effect Transistor (MOSFET). Other field effect transistors, such as for example, a Smart High Side Driver may also be used.

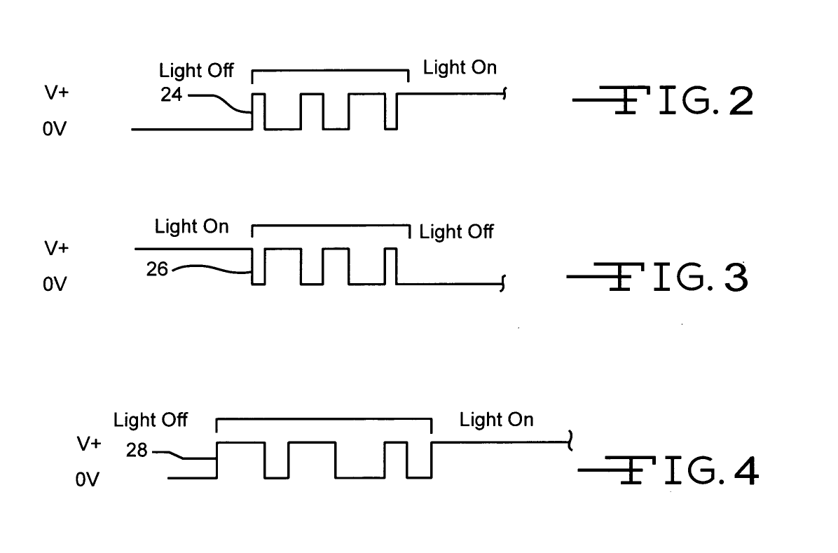

If desired, the control module 16 may include a user input function 20. The user input function 20 allows a user to select one of the plurality of PWM signals, or to select a time duration for the PWM signal, for example when a longer or shorter period of fade-on, fade-off, or flicker are desired. It will be understood however, that such a user input function 20 is not required. For example, the PWM signals may be pre-set to a fixed light effect. As used herein, light effect may be defined as any light pattern and/or duration, such as fade-on 24, fade-off 26, and flicker 28, as shown in FIGS. 2, 3, and 4, respectively.

A remote keyless entry (RKE) device 22 may also be provided and communicatively coupled to the light control module 16 via a known radio frequency (RF) signal.

As shown in FIG. 2, in accordance with a first instruction from the light control module 16, the transistor 18 may provide a first PWM output signal 24 modulated such that the pulse width gradually increases from zero (the off position) to a desired increase value greater than zero, thereby fading the headlight on from the off position (i.e., fade-on).

Similarly, as shown in FIG. 3, in accordance with a second instruction from the light control module 16, the transistor 18 may provide a PWM output signal 26 modulated such that the pulse width gradually decreases from the desired increased value greater than zero to zero (the off position), thereby fading the headlight from the on potion to the off position or dimming the headlight (i.e., fade-off).

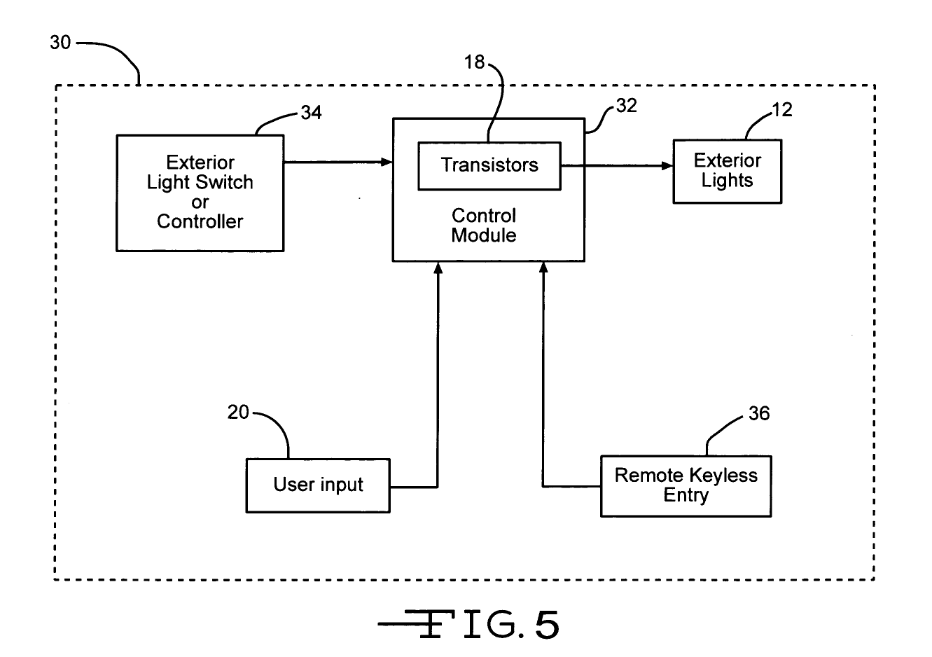

As shown in FIG. 4, in accordance with a third instruction from the light control module 16, the transistor 18 may provide a PWM output signal 28 modulated such that the pulse width varies in any desired pattern such that the light from the headlight is caused to illuminate intermittently or flicker.

The light control module 16 may receive signals from the switch 14, via the user input function 20, or from the RKE 22, and uses the received signals to selectively provide commands to the exterior lights 12, thereby selectively illuminating the exterior lights x (e.g., placing the exterior lights in one of a fade-on, fade-off, or flicker position).

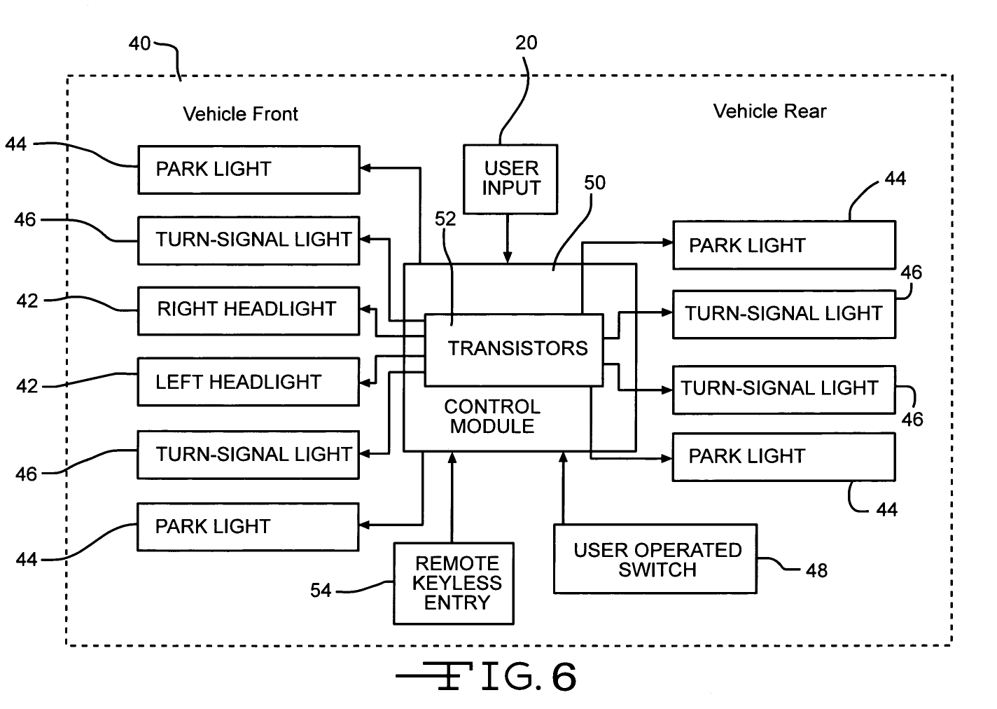

Referring now to FIG. 5, there is shown generally at 30 a second embodiment of a vehicle exterior light system for controlling one or more exterior lights 12 of a vehicle (not shown). It will be understood however, that the exterior vehicle lights 12 may be any desired light, such as for example, a low-beam headlight, a high-beam headlight, a turn signal, a park light, and any other exterior vehicle light.

The illustrated system 30 includes a light control module 32 communicatively coupled between the exterior lights 12 and a vehicle headlight switch or controller 34. The system 30 may be communicatively coupled between the exterior lights 12 and the vehicle exterior light controller 34 of any existing vehicle for which the operator desires lighting characteristics such as fade-on, fade-off, and/or flicker, as described herein above. The module 32 is substantially similar to the module 16 and includes the transistor 18 for delivering electric current from a power source (not shown) to the exterior vehicle lights 12.

If desired, the light control module 32 may include the user input 20. The user input 20 allows a user to select one of the plurality of PWM signals, or to select a time duration for the PWM signal, for example when a longer or shorter period of fade-on, fade-off, or flicker are desired. It will be understood however, that such a user input function 20 is not required. For example, the PWM signals may be pre-set to a fixed pattern and duration, such as fade-on 24, fade-off 26, and flicker 28, as shown in FIGS. 2, 3, and 4, respectively. Alternatively, the transistor 18 of the system 30 may provide a PWM output signal modulated such that the desired vehicle lights 12 fade-on, fade-off, and or flicker in any desired sequence and or combination.

The light control module 32 may receive signals from the exterior light controller 34, as illustrated in FIGS. 2, 3, and 4, via the user input 20 and uses the received signals to selectively provide commands to the exterior lights 12, thereby selectively illuminating the exterior lights 12 (e.g., placing the exterior lights in one of a fade-on, fade-off, or flicker position).

Referring now to FIG. 6, there is shown generally at 40 a third embodiment of a system for controlling one or more exterior lights of a vehicle (not shown). In the embodiment illustrated in FIG. 6, the exterior vehicle lights include headlights 42, park lights 44, and turn-signal lights 46. It will be understood however, that the exterior vehicle lights 42, 44, and 46 may be any other desired exterior vehicle light.

The illustrated system 40 includes the headlights 42, park lights 44, and turn-signal lights 46, one or more user operated switch 48, such as a headlight switch or a turn signal switch, a light control module 50, and a transistor 52. The transistor 52 is used to deliver electric current from a power source (not shown) to the exterior vehicle lights 42, 44, and 46. The lights 42, 44, and 46 and user operated switch 48 are communicatively coupled to the light control module 50. The system 40 may be communicatively coupled between one or more of the exterior vehicle lights 42, 44, and 46 and the light control module 50 of any existing vehicle for which the operator desires lighting characteristics such as fade-on, fade-off, and/or flicker, as described herein above.

As described herein above, the light control module 50 may be any type of control module, such as a body control module for controlling electronic devices such as door locks, interior and exterior lights, and other, non-engine electronic devices. Alternatively, the control module may be a controller for controlling only one or more vehicle lights.

If desired, the light control module 50 may include the user input 20. The user input 20 allows a user to select one of the plurality of PWM signals, or to select a time duration for the PWM signal, for example when a longer or shorter period of fade-on, fade-off, or flicker are desired. It will be understood however, that such a user input 20 is not required. For example, the PWM signals may be pre-set to a fixed pattern and duration, such as fade-on 24, fade-off 26, and flicker 28, as shown in FIGS. 2, 3, and 4, respectively.

If desired, the system 40 may include an RKE device 54 communicatively coupled to the light control module 32 via a known radio frequency (RF) signal.

The transistor 52 of the system 40 may provide a PWM output signal modulated such that the desired vehicle lights 42, 44, and 46 fade-on, fade-off, and or flicker in any desired combination or sequence. For example, each of the headlights 42, park lights 44, and turn-signal lights 46 may fade-on, fade-off, and or flicker together with identical patterns. Alternatively, the headlights 42, park lights 44, and turn-signal lights 46 may fade-on, fade-off, and or flicker in any desired combination with identical patterns or with different patterns.

The RKE 54 may be programmed to provide the operator with any of the various combinations of fade-on, fade-off, and or flicker described above. For example, The RKE 54 may have different buttons or button sequences to allow the operator to select the desired fade-on, fade-off, and or flicker pattern.

The principle and mode of operation of the vehicle exterior lighting fading effect system have been described in its various embodiments. However, it should be noted that the vehicle exterior lighting fading effect system described herein may be practiced otherwise than as specifically illustrated and described without departing from its scope.

What is claimed is:

1. A system for varying the output of an exterior light of a vehicle having a source of power, the system comprising:
an exterior vehicle light operatively connected to the source power; and
a controller for controlling the exterior vehicle light, the controller coupled between the exterior vehicle light and the source of power, the controller generating a plurality of power output signals to the exterior vehicle light;
wherein each of the plurality of power output signals defines a light effect.

2. The system according to claim 1, wherein the controller includes a field effect transistor.

3. The system according to claim 1, wherein the field effect transistor provides a plurality of Pulse Width Modulation (PWM) signals to the exterior vehicle light.

4. The system according to claim 3, wherein one of the plurality of PWM signals causes the exterior vehicle light to fade from an off position to an on position.

5. The system according to claim 3, wherein one of the plurality of PWM signals causes the exterior vehicle light to fade from an on position to an off position.

6. The system according to claim 3, wherein one of the plurality of PWM signals causes the exterior vehicle light to illuminate intermittently.

7. The system according to claim 3, wherein the control module further includes a user input function, such that a user may select one of the plurality of PWM signals.

8. The system according to claim 3, further including a user input to select a time duration for the one of a plurality of PWM signals.

9. The system according to claim 3, further including an actuator for actuating the transistor for providing a plurality of PWM signals.

10. The system according to claim 9, wherein the actuator is keyless remote entry device.

11. The system according to claim 3, wherein the exterior vehicle light controlled by the controller includes one of a low-beam headlight, a high-beam headlight, a turn signal, and a park light.

12. A system for varying the duty cycle of the control signal of an exterior light of a motor vehicle having a source of power, the system comprising:
an exterior vehicle light operatively connected to the source power; and
a control module for controlling the exterior vehicle light, the control module coupled between the exterior vehicle light and the source of power, the control module providing a plurality of Pulse Width Modulation (PWM) signals to the exterior vehicle light;
wherein each of the plurality of PWM signals defines a light effect.

13. The system according to claim 12, wherein the controller includes a field effect transistor.

14. The system according to claim 13, wherein the field effect transistor provides a plurality of Pulse Width Modulation (PWM) signals to the exterior vehicle light.

15. The system according to claim 13, wherein one of the plurality of PWM signals causes the exterior vehicle light to fade from an off position to an on position.

16. The system according to claim 13, wherein one of the plurality of PWM signals causes the exterior vehicle light to fade from an on position to an off position.

17. The system according to claim 13, wherein one of the plurality of PWM signals causes the exterior vehicle light to illuminate intermittently.

18. The system according to claim 13, wherein the light control module further includes a user input function, such that a user may one of select one of the plurality of PWM signals and select a time duration for the one of the plurality of PWM signals.

19. The system according to claim 13, further including an actuator for actuating the transistor for providing a plurality of PWM signals.

20. A control module for varying the output of an exterior light of a motor vehicle having a source of power, the control module comprising:
a control module housing;
a first connector for coupling the control module to a exterior vehicle light switch;
a second connector for coupling the control module to an exterior vehicle light;
a transistor coupled to the housing and providing a plurality of Pulse Width Modulation (PWM) signals to the exterior vehicle light;
wherein each of the plurality of PWM signals defines a light effect.
